(19) United States
(12) Patent Application Publication
(10) Pub. No.: US 2012/0034528 A1
(43) Pub. Date: Feb. 9, 2012

(54) High energy density electrical energy storage devices

(75) Inventor: Mark A. Wendman, Freemont, CA (US)

(73) Assignee: Recapping, Inc., Menlo Park, CA (US)

(21) Appl. No.: 13/068,832

(22) Filed: May 20, 2011

Related U.S. Application Data
(63) Continuation-in-part of application No. 12/656,463, filed on Jan. 29, 2010.
(60) Provisional application No. 61/206,816, filed on Feb. 2, 2009.

(51) Int. Cl. H01M 10/02; H01M 4/50; H01M 4/54; H01M 4/58; H01G 9/025; H01M 4/48; H01M 4/52; B82Y 30/00

(52) U.S. Cl. 429/300; 429/304; 429/314; 429/310; 429/316; 429/319; 252/182.1; 252/62.2; 361/525; 977/742; 977/780

(57) ABSTRACT

High electrical energy density storage devices are disclosed. The devices include electrochemical capacitors, electrolytic capacitors, hybrid electrochemical-electrolytic capacitors and secondary batteries. Advantageously, the energy storage devices may employ core-shell protonated perovskite submicron or nano particles in composite films that have one or more shell coatings on a protonated perovskite core particle, proton bearing and proton conductive. The shells may be formed of proton barrier materials as well as of electrochemically active materials in various configurations.

### REFERENCE TO RELATED APPLICATIONS

This application is a continuation in part of pending U.S. patent application Ser. No. 12/656,463 filed Jan. 29, 2010 that claims priority to U.S. Provisional Patent Application 61/206,816 filed Feb. 2, 2009.

### FIELD OF THE INVENTION

The disclosed invention generally relates to high-energy density electrical energy storage devices. The disclosed invention further relates to high-energy density electrical energy storage devices, proton electrochemical capacitors, electrolytic capacitors, hybrid proton electrochemical-electrolytic capacitors, hybrid ferroelectric proton electrochemical capacitors and batteries and batcaps, each formed of layers of series parallel cascaded core shell protonated nanoparticles.

### BACKGROUND OF THE INVENTION

Electrical energy storage devices include devices such as batteries, capacitors and hybrid solutions of each such as bat-caps. Popular types of capacitors include solid-state proton polymer electrochemical capacitors, linear dielectric and ferroelectric-based dielectric capacitors and solid-state electrolytic capacitors. Common types of batteries include primary (non-rechargeable) and secondary (rechargeable) batteries. Primary batteries include metal-air batteries such as Zn-air, Li-air and Al-air, alkaline batteries and lithium batteries. Common types of solid-state secondary batteries include nickel cadmium, nickel metal hydride and lithium ion batteries.

Proton conductive electrical energy storage devices include solid-state secondary batteries and solid-state proton polymer electrochemical capacitors. Each type of device employs an anode and a cathode on opposite sides of a solid, proton conducting ionomer electrolyte. The cathode and anode in each of these devices may include metal oxide particles on a metal layer. The metal oxide particles may be fused and activated to form a surface metal oxide layer cathode or anode that has a surface area greater than that of a continuous metal layer.

A solid-state electrolytic capacitor typically includes a dielectric formed by the anodization of a high surface area valve-acting metal such as Al, Ta or Ti, and a cathode such as an electrically conductive polymer and/or a conductive oxide such as MnO₂.

A solid-state multilayer ceramic capacitor typically employs a ferroelectric, paraelectric or linear perovskite type oxide such as BaTiO₃ and doped BaTiO₃ as a dielectric co-fired into multilayer structures with metals such as Ag, Ag—Pd, Pt, Ni and Cu.

Although electrical energy storage devices such as electrochemical, electrolytic and ferroelectric capacitors, as well as secondary batteries, have found wide utility, a continuing need exists for electrical energy storage devices suitable for achieving improved energy densities, power densities, operating voltages as well as reduced leakage. A further need exists for processes for manufacture of these types of improved electrical energy storage devices.

### SUMMARY OF THE INVENTION

The disclosed invention relates to high electrical energy density storage devices such as electrochemical capacitors, electrolytic capacitors, hybrid electrochemical-electrolytic capacitors, secondary batteries and batcaps. Advantageously, energy storage devices of the invention that employ protonated perovskites such as those that have insulating particle boundaries, electrochemically active particle boundaries surrounding protonated perovskites or combinations thereof such as in a core shell structure are unlikely to degrade such as when partially discharged, fully discharged or recharged.

In a first embodiment, the invention relates to devices of such as those that employ films that include nanoparticle oxide core-shell materials that have a core material that includes a protonated compound that have a perovskite crystal structure. The protonated compound may have at least one shell material in contact with the core material. The protonated compound may be a protonated perovskite of the formula ABO₃ where the proton concentration in the protonated perovskite is about 0.0001% or more by equivalent unit cell site occupation of oxygen sites in perovskite oxides of the formula ABO₃ where A may be Ag, Ba, Bi, Ca, Ce, K, Li, Mg, Mn, Pb, Na, Sr, Yb, or combinations thereof, and B may be Ce, Mg, Mn, Nb, Sb, Ta, Ti, Zr, Y and combinations thereof. In addition, NaMgF₃ may be employed as a perovskite type compound. Examples of perovskite compounds include but are not limited to BaTiO₃,PbTiO₃, (Sr,Ba)TiO₃, CaTiO₃, SrTiO₃, Na_{0.5}Bi_{0.5}TiO₃, Li_{0.5}Bi_{0.5}TiO₃ (Na,Ce)TiO₃, BaZrO₃, Ba(Zr,Y)O₃, BaCeO₃, Yb doped SrCeO₃, Nd doped BaCeO₃, (Ag,Li)NbO₃, (K_{0.5},Na_{0.5})NbO₃, (AgLi)TaO₃, (AgLi)SbO₃, NaMgF₃, YbMn₂O₅ and mixtures thereof. The protonated compound may have a proton concentration of about 0.001% to about 70% by volume. The shell material may be any one or more of proton barrier materials, electrochemically active materials, and combinations thereof. The core-shell material may be reversibly charged. The shell material may be a graded shell that varies in composition between proton barrier to electrochemically active.

The core shell materials and electrolytes may be employed in electrical energy storage devices such as electrochemical capacitors, electrolytic capacitors, hybrid electrochemical-electrolytic capacitors, secondary solid-state batteries and combinations thereof. These devices may include an anode, cathode and electrolyte. These devices also may include a nanoparticle battery. In addition, the core shell materials may be employed with an ionomer in a thick film composition. The thick film composition may include about 10 vol. % to about 99.9 vol. % protonated perovskite particles based on total volume of the composition.

The core-shell material such as a protonated perovskite core shell material may have a shell that is in the form of a graded structure that varies in composition from an outer proton barrier dielectric portion to an inner electrochemically active portion in contact with the core. Alternatively, the shell may have a bi-layer structure that includes an inner electrochemically active layer in contact with the core and an outer, proton barrier dielectric layer in contact with the electrochemically active layer. The electrically active layer may be electrochemically anisotropic. Regardless of structure, the core shell material may be subjected to electrothermal treatment to impart anisotropic, directional activity to the inner electrochemically active layer. In this aspect, such as where the core-shell material includes a non-spherical core such as a cylindrical protonated perovskite particle core, the distal ends of the core shell particle material may orient perpendicularly to an applied electrical field.

A graded shell structure may be made by well know methods such as chemical vapor deposition. Similarly, a layered structure may be made by chemical vapor deposition. During chemical vapor deposition to deposit a graded shell such as one that varies from an electrochemically active portion to a proton barrier portion, the composition is progressively varied during deposition. Similarly, chemical vapor deposit may be employed to deposit a layered shell by first depositing an electrochemically active material followed by deposition of a layer of protonated barrier material. The electrochemically active shell material may be any one or more of aluminum hydroxide, calcium hydroxide, magnesium hydroxide and mixtures thereof. The electrochemically active material employed may include any one or more of aluminum hydroxide, calcium hydroxide, magnesium hydroxide and mixtures thereof. Where anisotropic interfacial electrochemical activity between the shell coating and particle core such as a perovskite particle core is present, the electrochemically active layer material may be any one or more of aluminum hydroxide, calcium hydroxide, magnesium hydroxide and mixtures thereof. The proton barrier shell material may be any one or more of Al₂O₃, SiO₂, CaO, Si₃N₄, AlN, stoichiometric variations thereof and mixtures thereof.

Oriented core shell electrochemical shell activity may be induced by electrothermal treatment of the core shell material such as where the core shell material is in the form of composite film. During electrothermal treatment, the protonated compounds, prior to use in a core-shell protonated material such as a composite film, may be heated to about 50° C. to about 450° C. under an electric field of about 1 E⁵V/M to about 400 E⁶V/M for about 1 μsec to about 500000 sec. This electrothermal treatment may generate a proton concentration gradient in the protonated compounds and may generate anisotropic electrochemical activity in the core shell material as well as a proton concentration gradient in the protonated compounds.

In second embodiment, the invention relates to a composite proton conductive electrolyte suitable for use in a solid-state electrical energy device. The composite electrolyte includes a mixture of core-shell protonated material and a proton conductive ionomer. The core shell protonated material may be present in the electrolyte in an amount of about 0.1% or more by volume of the electrolyte. The ionomer preferably includes tetrafluoroethylene-perfluoro-3,6-dioxa-4-methyl-7-octenesulfonic acid copolymer ionomer. The composite electrolyte also may include one or more additives such as one or more of polysulfone, polyethersulfone, polybenzimidazole, polyimide, polystyrene, polyethylene, polytrifluorostyrene, polyetheretherketone and mixtures thereof. The composite electrolyte may further include electronically insulating nanotubes such as any one or more of carbon nanotubes, aluminosilicate nanotubes, titania nanotubes, nitride nanotubes, oxide nanotubes or mixtures thereof. In addition, the composite electrolyte may include an electronically insulating nanoporous material selected from the group consisting of zeolites and nanoporous sol gel dielectrics. The protonated compounds, prior to use in a core-shell protonated material such as a composite film, may be heated to a temperature of about 50° C. to about 450° C. under an electric field of about 1 E⁵V/M to about 400 E⁶V/M for about 1 μsec to about 500000 sec, or by repeated electrical pulses. This may generate a proton concentration gradient in the protonated compounds.

In a third embodiment, the invention relates to an electrical energy storage device that includes core-shell protonated material and a composite, proton conductive electrolyte. The protonated compounds, prior to use in a core-shell protonated material such as a composite film, may be heated to about 50° C. to about 450° C. under an electric field of about 1 E⁵V/M to about 400 E⁶V/M for about 1 μsec to about 500000 sec.

The core shell material may core material that may be symmetric or asymmetric such as in the form of cylindrical particles that have distal end portions and sidewall portions. In this configuration, the inner electrochemically active material may have greater electrochemical activity than the sidewall portions. In this configuration, moreover, the sidewall portions may display dielectric behavior when treated with an electric field. The electrochemically active material may be aluminum hydroxide, calcium hydroxide, magnesium hydroxide and mixtures thereof. The proton barrier material may be Al₂O₃, SiO₂, CaO, Si₃N₄, AlN and mixtures thereof. The core material may be in the form of particles, nanowires and mixtures thereof.

In another embodiment, the invention relates to a solid-state secondary cell that includes an anode, cathode and proton conducting electrolyte wherein the electrolyte includes a mixture of core shell protonated material, proton conducting ionomer and oxide dielectric dispersed between particles of the core-shell protonated material wherein the core shell protonated material includes a core-shell protonated perovskite material. The protonated material may be present in the proton conducting electrolyte in an amount of about 1% to about 99%, the proton conductive ionomer may be present in the proton conducting electrolyte in an amount of about 0.01% to about 20% and the oxide dielectric may be present in the proton conducting electrolyte in an amount of about 0.01% to about 40%, where all amounts are based on total weight of the electrolyte. The anode of the solid-state secondary cell may include a conductive metal such as aluminum and a proton conductive metal hydride such as aluminum hydride. The cathode of the cell may include a metal containing compound such as one or more metal oxides of the formula MₓO_{y} where 0.001<x≦53.00 and 0.001<y≦7.00, one or more metal hydroxides of the formula Mₓ(OH)_{y} where 0.001<x≦1.00 and 0.001<y≦3.00 or mixtures thereof where in each of MₓO_{y} and Mₓ(OH)_{y}, M may be Al, Ru, Mn, Ni, Ag, alloys thereof and mixtures thereof.

Electrical energy storage devices such as batteries, capacitors and batcaps that employ any one or more of protonated perovskites that have a core-shell structure, protonated perovskites and ionomer such as proton conductive ionomer having a polymer insulating shell or combinations thereof may achieve energy densities of about 30 Wh/kg or more, and/or operating voltages of about 20 V or more and/or power densities of about 80 W/kg or more.

Energy storage devices such as secondary batteries that employ protonated oxides such as protonated core-shell oxide advantageously may undergo reversible protonation and may be capable of mobile protonation and may achieve high energy density in a solid-state form. The protonated core shell oxide may be able to undergo reversible charge separation and may function as a nanoparticle battery.

Having summarized the invention, the invention is described in further detail below by reference to the following detailed description non-limiting examples.

### DETAILED DESCRIPTION OF THE INVENTION

### Materials

Protonated compounds such as protonated perovskite oxides that may be employed in electrical energy storage devices such as electrochemical, electrolytic and hybrid electrochemical-electrolytic capacitors and batteries preferably have a core-shell structure. Protonated perovskites such as protonated perovskite type oxides that may be employed typically have high proton concentrations of chemisorbed and/or lattice protons of about 0.01% or more equivalent unit cell site occupation of oxygen sites in ABO₃ perovskite type oxides. Typically, the protonated perovskites employed prior to formation into solids such as composite-ionomer electrolytes, or before preconditioning, may have a proton concentration of about 0.1% to about 70% by equivalent unit cell site occupation of oxygen sites in ABO₃ type oxide.

Perovskites that may be protonated for use in manufacture of electrical energy storage devices include but are not limited to titanates such as but not limited to PbTiO₃, BaTiO₃, mixtures thereof and solid solutions thereof; doped barium titanates such as but not limited to rare earth doped barium titanates such as (Sr,Ba)TiO₃; alkaline earth titanates such as but not limited to CaTiO₃, SrTiO₃, Na_{0.5}Bi_{0.5}TiO₃, Li_{0.5}Bi_{0.5}TiO₃ and (Na,Ce)TiO₃; zirconates such as but not limited to BaZrO₃ and Ba(Zr,Y)O₃; cerates such as but not limited to BaCeO₃, Yb doped SrCeO₃ and Nd doped BaCeO₃; niobates such as but not limited to alkali niobates such as but not limited to (Ag,Li)NbO₃ and (K_{0.5},Na_{0.5})NbO₃; tantalates such as but not limited to alkali tantalates such as but not limited to (AgLi)TaO₃; antimonates such as but not limited to alkali antimonates such as but not limited to (AgLi)SbO₃; fluorides such as but not limited to NaMgF₃; oxygen-deficient compounds such as but not limited to ReBaM₂O₅ where Re is rare earth, M is Mn, Fe or Co such as but not limited to YbMn₂O₅. Any of the forgoing perovskites may be modified by chemical doping during synthesis to modify ferroelectric and paraelectric properties such as permittivity and Curie temperature of the perovskites.

Protonated perovskite oxides may be employed in the form of a core shell configuration where a protonated perovskite such as a partially protonated perovskite core particle is encapsulated within one or more surrounding shells. The protonated perovskite core may be employed in the form of particles, in films and as combinations thereof. The shells may provide proton barrier properties, electrochemical properties and combinations thereof. Advantageously, core shell protonated perovskites may function as nanoparticle batteries that may be reversibly charged individually or in series or in parallel or combined series. parallel.

Thin shell coatings on protonated perovskite particles may be employed with protonated perovskites to form a variety of core-shell configurations. These configurations include but are not limited to protonated perovskite core having a shell formed of a proton barrier material in contact with the core; protonated perovskite core having a shell formed of a proton barrier material in contact with the core and an outer electrochemically active shell; protonated perovskite core having a shell formed of a electrochemically active material in contact with the core, an intermediate proton barrier layer and an outer electrochemically active shell; graded shells that vary from inner proton barrier to electrochemically active outer layer or vice-versa, and combinations thereof. Shell coatings after electrothermal treatment may possess distal oriented internal electrochemical activity and non-distal sidewall dielectric properties. Composite films formed of material such as core shell particles may achieve additive series cascade voltages through the thickness of a composite film such as when positioned between electrodes and may enable energy capacity increases proportional to the area of the film.

Electrochemically active materials that may be employed as shell materials include but are not limited to aluminum hydroxide, calcium hydroxide and magnesium hydroxide and mixtures thereof. Electrochemically active shell materials may have a thickness of about 0.5 nm to about 60 nm, and graded shells may have a thickness of about 0.5 nm to about 60 nm.

Proton barrier shell materials may include but are not limited to binary metal oxides, electronically insulating nitrides and mixtures thereof. Binary metal oxides that may be employed include but are not limited to Al₂O₃, SiO₂, CaO, doped variations thereof and mixtures thereof. Electronically insulating nitrides that may be employed include but are not limited to Si₃N₄, AlN variations of these stoichiometries including chemical doping thereof and mixtures thereof.

Proton barrier shell materials may be in the form of thin films that possess proton and/or hydrogen barrier properties but permit proton/hydrogen transport across thin film defects in proton barrier shell thicknesses of about 1 nm to about 50 nm. The proton barrier shell materials also may be in the form of a continuous coating.

Presence of a proton barrier shell may function to limit proton loss to enable reduced incidence of protonated perovskite surface layer deoxidation. Proton barrier shells may reduce undesirable formation of electrical conduction paths on the surface of protonated perovskites that may degrade energy storage retention such as may occur in uncoated particles due to proton migration induced by particle surface dehydroxylation.

The thickness of a shell coating such as a proton barrier shell coating may vary to enable possible retention of surface electrical and insulating properties despite proton loss that might occur during use or during preconditioning. The thickness of the shell coating, however, may be chosen to minimize impedance of proton transport during preconditioning such as by thermally assisted electrical field extraction of protons from protonated compounds such as protonated perovskite oxides.

### Synthesis of Protonated Perovskites

Protonated compounds such as protonated perovskites may be formed by methods such as hydrothermal synthesis and solution synthesis. Use of any one or more of deionized water and distilled water that has an electrical resistivity of more than about 15 M ohm-cm may be employed in synthesis. The water, prior to use in synthesis of protonated perovskites or for use in treating the protonated perovskites, may be treated by ozonation or UV methods to reduce total organic carbon content.

Protonated compounds of protonated perovskites such as protonated ferroelectric oxides may be made by hydrothermal synthesis as well as by solution synthesis. One method that may be employed to produce protonated perovskites by hydrothermal synthesis is illustrated in Zhao et al, Ceramics International 34 (2008) 1223-1227, the teachings of which are incorporated by reference herein in their entirety.

Zhao et al. teaches hydrothermal synthesis of protonated perovskites such as (Ba,Sr)TiO₃ by use of a high-pressure autoclave. A range of mixtures of aqueous solutions of Ba(OH)₂ and of aqueous Sr(OH)₂ at various concentrations may be used. The solutions may be prepared with deionized water previously boiled for 30 min or more to eliminate dissolved CO₂. A mixture of Ba(OH)₂ and Sr(OH)₂ solutions is poured into a container and placed into a high-pressure autoclave in the presence of a titanium support. The autoclave is sealed and heated to a temperature of about 50° C. to about 200° C. to undergo hydrothermal and solution reaction. The resulting (Ba,Sr)TiO₃ is removed, rinsed with CO₂-free deionized water and dried.

### Preconditioning

The proton levels in protonated perovskites may be modified in a preconditioning step prior to forming of the protonated perovskites into solid bodies for use such as composite-ionomer electrolyte prior to use in an electrical energy storage device such as a reversible electrical energy storage device such as a solid state secondary cell. The protonated perovskites may be modified in protonation level by treatment with hydrogen at a temperature of about 50° C. to about 1300° C. at pressure of about 5 mTorr to about 3000 psi; with forming gas at a temperature of about 50° C. to about 1300° C. at a pressure of about 5 mTorr to about 3000 psi; with steam at a temperature of about 50° C. to about 1300° C. at a pressure of about 5 mTorr to about 3000 psi, with boiling water or combinations thereof, or with electrolysis-electrochemical reaction treatments using applied DC or AC electrical fields in a solution based electrochemical cell configuration.

Thermal assisted, electric field initiated proton migration at temperatures of about 50° C. to about 550° C. under electric fields of about 1 E⁵V/M to about 400 E⁶V/M also may be used to precondition protonated perovskites to enable increases in working density of reversible transportable protons in electrical energy storage devices such as a capacitor or battery.

Preconditioning may be used to achieve high proton concentration gradients wherein protons segregate such as within protonated perovskite oxides. This may enable achievement of higher proton charge densities such as by reducing the internal field strength present with combined ferroelectric fields and proton fields. High proton concentration gradients that may occur due to segregation of proton rich and proton deficient regions may be aided by proton barrier shell coating.

During preconditioning, protonated perovskites such as protonated ferroelectric oxides may be deprotonated to a desired extent while enabling proton transport within the protonated perovskite particle, within ionomer-protonated perovskite composites, at particle boundaries between ionomer and the perovskite, or any combination. therein. Typically, protonated compounds such as protonated perovskites may be deprotonated to about 0.001% to about 70% net protonation based on based on the ABO₃ oxygen site occupation (O of O₃ of prototypical ABO₃ perovskite crystal unit cell) of the unprotonated perovskite.

Deprotonation to a desired extent may be performed by thermally assisted electric field treatment at about 50° C. to about 550° C. under an electric field of about 1 E⁵ V/m to about 400 E⁶ V/m. Heating of the protonated perovskites may be performed by methods such as laser, microwave, radio frequency, infrared, induction heating, as well as use of thermal heating chambers or furnaces. The extent of deprotonation may be monitored by analytical methods such as TGA (mass loss), EGA (evolved gas) and FTIR (OH bond density) and electrical properties, both in-situ and ex-situ measurements.

### Proton Concentration Gradients

Protonated perovskites that have a core-shell configuration may be electrothermally treated to generate a proton concentration gradient within the protonated perovskite core particles. Proton concentration gradients may form in the interior of core shell protonated perovskite particles, especially when the shell coating possesses proton barrier properties. The proton concentration gradients may enable increased proton mobility along defects present in proton gradient regions to enable electrical energy storage devices to achieve higher reversible charge separation energy densities.

A proton concentration gradient may form in the perovskite particle interior of protonated core shell nanoparticle perovskites by subjecting protonated compounds and solid solutions such as in perovskite type oxides to electrothermal treatment under an electrical field at elevated temperatures to cause migration of protons. In some aspects, electrothermal treatment may concentrate protons directionally within core shell protonated perovskites particles, at distal shell regions surrounding the protonated perovskite particles, or combinations thereof. An increased proton concentration gradient may form by subjecting protonated perovskites such as protonated perovskite type oxides to an electrical field of about 100 Kilovolt/M to about 400 Megavolt/M at temperatures of about 20° C. to about 550° C., preferably about 50° C. to about 550° C. for about 1 μsec to about 50000 sec.

Where the core shell material employs a non-spherical, protonated particle core such as a cylindrical protonated perovskite particle core, the core shell material may be subjected to an electrical field of about 100 KV/m to about 400 MV/m at a temperature of about 20° C. to about 550° C., preferably about 50° C. to about 550° C. for about 1 μsec to about 50000 sec. This may enable the distal ends of the core shell particle to exhibit higher electrochemical activity than the sidewalls of the core-shell material. Also, such as where the core shell particles are in the form of cylindrical core shell particles, the sidewalls of the core shell particles that are oriented parallel to an applied electric field may exhibit dielectric properties and the distal ends of the core shell particles may exhibit reversible electrochemical activity. An electrical energy storage device such as an ultra capacitor that employs these particles sustain higher electrical fields of about 15 V to about 10,000V as well as achieve improved directional, high energy density and charge retention.

Proton concentration gradients that may form by use of electric fields at elevated temperatures such as due to segregation of protons to a desired region shell coated protonated perovskite particles, may generate a self-shielding effect between ferroelectric charge displacements, and proton charge fields in individual protonated particles or between individual protonated particles within a cluster of protonated particles where the protonated particles have a size within the range of micron to nanoscale. The self-shielding effect may enable achievement of high proton charge densities of about 0.001% to about 50% equivalent unit cell site occupation of oxygen sites in ABO₃ perovskite type oxides.

Protonated compounds such as protonated perovskite oxides such as when employed in core-shell configurations may function as a proton charge source for use in a reversible energy storage device such as solid-state secondary battery or capacitor. In this aspect, electrical energy storage materials such as films formed of core shell protonated perovskite submicron particles or protonated perovskite nanoparticles may be electrostatically and or electrochemically coupled. This may enable achievement of voltages beyond that of prior art solid-state secondary batteries, and energy densities beyond that of prior art ferroelectric capacitor devices.

Proton charge sources also may be any portion of the core shell particles, shell coatings, interstitial material between core shell particles, exterior surfaces of shell coatings, as well as electrodes employed for connection to an electrical energy storage device. Protons may be sourced from within the core-shell particles as well as from bulk mobile (electrode to electrode) protons in the solid state. In this aspect, the particle size of the perovskite oxide particles may range from about 5 nm to about 3000 nm.

### Composite Electrolyte

Protonated perovskites such as perovskite type oxides that have a protonated perovskite core-shell structure may be employed in admixture with materials such as proton conductive ionomers such as Nafion to form a composite electrolyte of such as protonated perovskite core shell particles and proton conductive ionomer. The composite electrolyte may have regions of local thinning and/or surface interface effects at particle boundaries between the ionomer and a perovskite type particle such as a protonated perovskite core-shell particle. Energy storage devices where composite electrolytes are employed that include protonated perovskites such as protonated perovskite core shell particles may achieve very high voltages and energy densities.

Protonated perovskites such as protonated perovskites that have a core shell structure may be employed in various forms such as particles, films and combinations thereof when in admixture with polymers such as ionomers. In this aspect, the protonated perovskites may have a particle size of about 2 nm to about 900 nm, preferably about 50 nm to about 500 nm, more preferably about 100 nm to about 200 nm. The particles may be symmetric or asymmetric such as in the form of cylindrically shaped particles. Films that employ protonated materials such as protonated perovskites may have a thickness of about 1 micron to about 30 microns per layer. The films may be stacked and the stacked, multi-layer films may be separated by electrodes. These steps may be repeated to produce a multi-layer capacitor that may be used in surface mount applications. These steps also may be repeated to produce devices where the multilayer active films are connected in parallel to produce a monolithic composite.

Electrically insulative polymers, proton insulative polymers and mixtures thereof may be employed in the composite electrolyte. Also, atypical ionomers such as dielectric rubbers such as silicones, butyls and combinations thereof may be employed in a composite electrolyte. Atypical ionomers that may be employed also include rubbers that have dielectric polymers that possess ionomeric properties and dielectric properties also may be employed.

Mixtures of protonated perovskites such as protonated ferroelectric perovskite type oxides such as protonated perovskites that have a core shell structure and polymer wherein the protonated ferroelectric perovskites constitute about 70% or more by volume of the electrolyte mixture may enable proton transport above that of the protonated perovskite per se.

Composite electrolyte mixtures that include protonated perovskite such as protonated perovskites that have a core shell structure and ionomer may enable formation of composite electrolytes in the form of dense solids at process temperatures below about 200° C. by low temperature isostatic pressing at pressures of about 50 PSI to about 3000 PSI. Low temperature isostatic pressing or low temperature hot uniaxial pressing at process temperatures below about 200° C. at pressures of about 50 PSI to about 3000 PSI may enable formation of dense composite electrolyte of about 5% or less porosity, and which may be more resistant to electric breakdown, deprotonation and cracking.

Use of process temperatures below about 200° C. also may enable retention of the majority of lattice and chemisorbed protons/hydroxyls in protonated compounds such as in protonated perovskites such as protonated perovskites that have a core shell structure during manufacture of an energy storage device such as solid-state secondary batteries and capacitors. Use of low temperatures below about 200° C. may enable use of protonated perovskites that have high proton concentrations in excess of 0.01% equivalent unit cell site occupation of oxygen sites in ABO₃ type perovskite oxides. In this aspect, these low process temperatures may enable retention of high proton concentrations in excess of about 0.01% equivalent unit cell site occupation of oxygen sites in ABO₃ type perovskite oxides, and higher protonation levels, that are non-site specific averaged over the active film volume.

Use of low processing temperatures that are far below the typical 1000° C. common to conventional ceramics sintering greatly expands the variety of materials that may be used in manufacture of electrical energy storage devices and may reduce the likelihood of electrical shorting defects that occur at higher temperatures due to diffusion of electrode metallurgies into the electrolyte. Also, use of low process temperatures may enable achievement of improved crack resistance in composite electrolytes, improved humidity resistance, improved shock resistance and enable processing of thick films that include protonated compounds such as protonated perovskites that have a core shell structure at temperatures below the lattice and chemisorbed deprotonation temperatures of protonated perovskites.

The low process temperatUres further may enable achievement of high solid-state concentrations of protons in protonated compounds such as protonated perovskites that have a core shell structure, and use of operating voltages that exceed those seen in liquid electrolyte capacitors and batteries. The low process temperatures also may enable retention of high proton charge densities achieved during manufacture of protonated perovskite such as protonated perovskites that have a core shell structure and may enable thermodynamic introduction of high proton concentrations to form ionomer composite electrolytes subsequent to synthesis of protonated perovskites such as by any of hydrothermal synthesis or solution synthesis.

Protonated perovskite type oxides such as protonated perovskites that have a core shell structure may be employed in manufacture of energy storage devices such as solid-state secondary batteries, capacitors and batcaps. Protonated perovskite type oxides such as protonated perovskites that have a core shell structure that may be employed include but are not limited to those that possess ferroelectric properties, paraelectric properties and combinations thereof, including but not limited to layered perovskite crystal structures, tungsten bronze and the like. Films of metals such as foils or metal/metal oxide particles may be employed to form electrode connections in those types of electrical energy storage devices.

Protonated oxides such as protonated perovskites that have a core-shell particle configuration may be admixed with a variety of additional materials. The protonated perovskites are permeable to at least one of protons and hydrogen and may enable proton transport in bulk or in interfacial regions or thin layer regions present at particle boundaries between the protonated perovskites and additional materials such as an ionomer. Examples of additional materials that may be admixed with protonated perovskites include but are not limited to polymers such as ionomers such as proton conductive ionomers. Advantageously, proton conductive ionomers may function as a water barrier and as an electron dielectric.

Examples of ionomers which may be admixed with protonated compounds such as protonated perovskites such as protonated perovskites that have a core shell structure include but are not limited to tetrafluoroethylene-perfluoro-3,6-dioxa-4-methyl-7-octenesulfonic acid copolymer (“NAFION”); sulfonated-2,6-dimethyl polyphenylene oxide; sulfonated (or phosphonated-)2,6-diphenyl polyphenylene oxide; polysulfone; polyethersulfone; polybenzimidazole; polyimide; polystyrene; polyethylene; polytrifluorostyrene; polyetheretherketone (PEEK) and liquid crystal polymers (e.g., Vexar, PBO. Other ionomers that may be admixed with protonated compounds such as protonated perovskites such as protonated perovskites that have a core-shell configuration include but not limited to thermally and/or optically curable epoxies; ionomers such as those that include moieties such as nitrile and butyl moieties; fluorinated ionomers; thinned ionomers formed by thinning of electron insulating polymers to generate thinned regions that function as ionomers when admixed with particles of other materials. In-situ generated ionomers may form in particle boundary regions between protonated perovskites core particles and surrounding shells as in perovskite core shell particles that include one or more shell coatings on the protonated perovskite core particles.

Protonated oxide compounds such as protonated perovskites such as core-shell protonated perovskites may be employed with polymers such as ionomers in thick film compositions. The thick film compositions may be formulated to maintain stable protonation levels such as after their use such as in MLC type capacitors and batteries. As used herein, stable protonation level is understood to mean a variation of plus or minus about 50% of the protonation level just prior to use. Where thick film compositions employ protonated perovskites such as protonated perovskites that have a core shell structure and an ionomer, the thick film ionomer composition may include about 0.001% equivalent unit cell site occupation of oxygen sites in ABO₃ type perovskite oxides, to about 99.9% equivalent unit cell site occupation of oxygen sites in ABO₃ perovskite type oxides, based on the total volume of the thick film composition. The term “thick film” as used herein refers to one or more deposited films that typically have a single layer thickness of about 0.5 microns or more. Thick films may be used to form a unitary component such as a cathode, hybrid protonated ionomer or anode to about 5000 microns composite multilayer/stacked electrode ionomer composite thickness.

Composite electrolytes that include protonated perovskites such as core shell protonated perovskites and ionomer may be admixed with electronically insulating nanotubes such as carbon nanotubes, aluminosilicate nanotubes such as asbestos nanotubes, titania nanotubes as well as nanotubes formed of electronically insulating nitride nanotubes, electronically insulating oxides nanotubes, or mixtures thereof. The nanotubes employed may be rendered electrically insulative or semiconducting by chemical functionalization in vapor or plasma or liquid treatments. The nanotube compositions may be fabricated into, for example, films such as thick films that include inorganic or organic dielectrics. When employed in films, the lengths of the nanotubes preferably are less than about 50% of the thickness of the film layer formed from the admixture. The protonated perovskite-nanotube ionomer compositions may include a combined volume of about 0.01 vol % to about 99 vol % nanotubes in addition to protonated perovskites such as core shell protonated perovskites nanoparticles and submicroparticles, remainder ionomer.

Protonated compounds such as core shell protonated perovskites may be mixed with one or more ionomers and electronically insulating nanoporous materials such as zeolite, nanoporous, sol gel dielectrics and combinations thereof that have a typical pore size less than about 4 nm. The resulting mixtures may have about 1 vol % to about 99.5 vol % protonated perovskites, remainder ionomer and electron insulating nanoporous materials. Zeolites that may be employed include but are not limited to microporous aluminosilicate and mixtures thereof; sol-gel dielectrics that may be employed include but are not limited to silicon dioxide and mixtures thereof.

Protonated perovskite type oxides such as core-shell protonated perovskites advantageously may be employed in solid-state secondary cells and solid-state secondary batteries. The cells include an anode that may employ a conductive metal, a binder and a proton conductive metal hydride or a mixture of proton conductive metal hydrides. The metal may be one or more of Al, C, Cu, Ni, Na, Li, alloys thereof or mixtures thereof. The binder may be a fluorinated olefin such as polytetrafluoroethylene (“PTFE”), polymers such as polyethyleneterephthalate (“PET”), or mixtures thereof. The amounts of proton conductive metal hydride, conductive metal and binder may vary. Generally, metal hydride may be present in an amount of about 0.2% to about 10%, conductive metal may be present in an amount of about 50% to about 90% and binder may be present in an amount of about 0.5% to about 40%, all amounts based on the weight of the anode.

A solid-state secondary cell further includes a cathode and an electrolyte. The cathode may include a binder and metal containing compound such as a metal oxide of the formula MₓO_{y} where 0.001<x≦3.00 and 0.001<y≦7.00, a metal hydroxide such as of the formula Mₓ(OH)_{y} where 0.001<x≦1.00 and 0.001<y≦3.00, or mixtures thereof where in MₓO_{y} 0.001<x≦3.00 and 0.001<y≦7.00 and where in Mₓ(OH)_{y} 0.001<x≦1.00 and 0.001<y≦3.00. M may be any one or more of Al, Ru, Mn, Ni, Ag, alloys thereof and mixtures thereof. The Mₓ(OH)_{y} present in the cathode may be formed in situ by electrothermal treatment of an MₓO_{y}. MₓO_{y}, Mₓ(OH)_{y} and combinations thereof may be present in the cathode in an amount of about 0.01% to about 70% where all amounts are based on the weight of the cathode. The electrolyte may be proton-conducting electrolyte that includes a mixture of protonated perovskites such as core shell protonated perovskites, proton conductive ionomer and oxide dielectric dispersed between particle boundaries of protonated perovskites such as protonated perovskites that have a core shell structure where all amounts are based on the weight of the cathode. The amounts of protonated perovskites such as protonated perovskites that have a core shell structure, proton conductive ionomer and oxide dielectric may vary. Typically, protonated perovskites such as protonated perovskites that have a core shell structure may be present in the proton conducting electrolyte in an amount of about 1% to about 99%, the proton conductive ionomer may be present in an amount of about 0.1% to about 20% and the oxide dielectric may be present in an amount of about 0.1% to about 40%, where all amounts are based on the total weight of the electrolyte. The protonated perovskites such as protonated perovskites that have a core shell structure employed in the electrolyte typically are protonated to an amount in excess of about 0.01% H based on equivalent unit cell site occupation of oxygen sites in ABO₃ perovskite type oxides.

The invention is further illustrated below by reference to the following non-limiting examples

### EXAMPLE 1

### Manufacture of Proton Electrochemical Capacitor that Employs Composite Electrolyte that includes Core Shell Protonated Perovskites

10 gms of conductive slightly oxidized aluminum particles that have a mean particle size of 100 nm is mixed with 5 gms of Nafion particles that have a mean particle size of 50 nm in a mixer for 5 min so that an electrochemical capacitor cathode material that includes of a mixture of electrically-conductive aluminum metal and Nafion ionomer may be produced. The cathode material then is dried to form a cathode layer precursor.

100 gms of protonated barium titanate particles that have a mean particle size of 100 nm and that have a 2 nm thick shell coating of Al₂O₃ dielectric is mixed with 2 gms of Nafion particles that have a mean particle size of 50 nm so that a composite, electrochemical capacitor electrolyte material may be produced. The 2 nm coating of Al₂O₃ dielectric on the protonated barium titanate particles may be formed by atomic layer deposition. The composite proton electrolyte precursor material is applied as a paste to the cathode layer precursor and dried so that a composite, electrolyte material may be produced.

10 gms of electrically conductive, slightly oxidized aluminum particles that have a mean particle size of 100 nm is mixed with 5 gms of proton conductive Nafion particles that have a mean particle size of 50 nm so that an electrochemical capacitor anode precursor material of electrically-conductive slightly oxidized aluminum particles and Nafion ionomer may be produced.

The anode precursor material then is applied as a paste to the composite ionomer electrolyte and then dried so that an assembly of cathode precursor layer, composite proton electrolyte precursor layer and anode precursor layer may be produced. The assembly then is hot pressed at 2000 PSI and 100° C. to bond each of the anode precursor layer and cathode precursor layer to the composite electrolyte precursor layer so that a high proton density electrochemical capacitor may be formed. Electrical leads of aluminum then are attached.

### EXAMPLE 2

The method of example 1 is followed except that the 2 nm coating of alumina is replaced with Al(OH)₃ and the electrical leads are PbSn.

### EXAMPLE 3

### Solid State Secondary Cell

10 gms of conductive slightly oxidized nickel particles that have a mean particle size of 100 nm is mixed with 5 gms of Nafion particles that have a mean particle size of 50 nm in a mixer for 5 min so that an cathode material that includes of a mixture of nickel and Nafion may be produced. The cathode material then is dried to form a cathode layer precursor.

100 gms of protonated strontium titanate particles that have a mean particle size of 100 nm and a 2 nm thick shell coating of Al₂O₃ dielectric is mixed with 2 gms of Nafion particles that have a mean particle size of 50 nm so that a composite, electrochemical capacitor electrolyte material may be produced. The 2 nm coating of Al₂O₃ dielectric on the protonated strontium titanate particles may be formed by atomic layer deposition. The composite proton electrolyte precursor material is applied as a paste to the cathode layer precursor and dried so that a composite, electrolyte material may be produced.

10 gms of electrically conductive, slightly oxidized aluminum particles that have a mean particle size of 100 nm is mixed with 5 gms of Nafion particles that have a mean particle size of 50 nm so that an anode precursor material of aluminum and Nafion may be produced.

The anode precursor material then is applied as a paste to the composite ionomer electrolyte and then dried so that an assembly of cathode precursor layer, composite proton electrolyte precursor layer and anode precursor layer suitable for use in a secondary cell may be produced. The assembly then is hot pressed at 2000 PSI and 100° C. to bond each of the anode precursor layer and cathode precursor layer to the composite electrolyte precursor layer so that a high proton density secondary cell may be formed. Electrical leads of aluminum then are attached.

1. A core-shell protonated material having a protonated core material comprising a protonated compound having a perovskite crystal structure and at least one shell material in contact with the core material wherein the protonated compound has a proton concentration of about 0.001% or more by equivalent cell site occupation of oxygen sites in the perovskite crystal structure wherein the shell material varies from an inner electrochemically active material in contact with the core material to a proton barrier dielectric outer material.

2. The core-shell protonated material of claim 1 wherein the protonated compound is selected from the group consisting of PbTiO₃, BaTiO₃, (Sr,Ba)TiO₃, CaTiO₃, SrTiO₃, Na_{0.5}Bi_{0.5}TiO₃, Li_{0.5}Bi_{0.5}TiO₃, (Na,Ce)TiO₃, BaZrO₃, Ba(Zr,Y)O₃, BaCeO₃, Yb doped SrCeO₃, Nd doped BaCeO₃, (Ag,Li)NbO₃, (K_{0.5},Na_{0.5})NbO₃, (AgLi)TaO₃, (AgLi)SbO₃, NaMgF₃, YbMn₂O₅ and mixtures thereof.

3. The core-shell material of claim 1 wherein the inner electrochemically active layer is electrochemically anisotropic.

4. The core shell material of claim 3 wherein the material comprises a core in the form of a particle having distal end portions and side wall portions wherein the inner electrochemically active material has greater electrochemical activity than the side wall portions.

5. The core shell material of claim 4 wherein the side wall portions have dielectric behavior.

6. The core-shell material of claim 1 wherein the electrochemically active material is selected from the group consisting of Al₂O₃, SiO₂, CaO, Si₃N₄, AlN, aluminum hydroxide, calcium hydroxide, magnesium hydroxide and mixtures thereof.

7. The core-shell material of claim 1 wherein the proton barrier material is selected from the group consisting of Al₂O₃, SiO₂, CaO, Si₃N₄, AlN and mixtures thereof.

8. The core shell protonated material of claim 2 wherein the core material is in the form of particles, nanowires and mixtures thereof.

9. A composite proton conductive electrolyte suitable for use in a solid-state electrical energy device comprising a mixture of the core-shell material of claim 1 and a proton conductive ionomer.

10. The composite electrolyte of claim 9 wherein the protonated core material is present in the electrolyte in an amount of about 0.1% or more by volume of the electrolyte.

11. The composite electrolyte of claim 9 wherein the ionomer comprises tetrafluoroethylene-perfluoro-3,6-dioxa-4-methyl-7-octenesulfonic acid copolymer.

12. The composite electrolyte of claim 9 further comprising an additive selected from the group consisting of polysulfone, polyethersulfone, polybenzimidazole, polyimide, polystyrene, polyethylene, polytrifluorostyrene, polyetheretherketone and mixtures thereof.

13. The composite electrolyte of claim 9 further comprising electronically insulating nanotubes selected from the group consisting of carbon nanotubes, aluminosilicate nanotubes, titania nanotubes, nitride nanotubes, oxide nanotubes and mixtures thereof.

14. The composite electrolyte of claim 9 further comprising an electronically insulating nanoporous material selected from the group consisting of zeolites, nanoporous sol gel dielectrics and mixtures thereof.

15. An electrical energy storage device comprising the core-shell material of claim 1.

16. The device of claim 15 further comprising the electrolyte of claim 9.

17. The device of claim 15 wherein the device is selected from the group consisting of electrochemical capacitors, electrolytic capacitors, hybrid electrochemical-electrolytic capacitors, secondary solid state batteries and combinations thereof.

18. The device of claim 17 wherein the device includes an anode, cathode and electrolyte.

19. The device of claim 17 wherein the electrochemical capacitor is a proton electrochemical capacitor comprising the electrolyte of claim 13.

20. The device of claim 17 wherein the device is a solid-state secondary cell comprising the electrolyte of claim 9.

21. A nanoparticle battery comprising the material of claim 1.

22. A thick film composition comprising the core-shell protonated material of claim 1 and an ionomer.

23. The thick film composition of claim 22 wherein the composition comprises about 10 vol. % to about 99.9 vol. % protonated perovskite particles based on total volume of the composition.

24. A solid-state secondary cell comprising an anode, cathode and proton-conducting electrolyte wherein the electrolyte comprises a mixture of core shell protonated material, proton conducting ionomer and oxide dielectric dispersed between particle boundaries of the core-shell protonated material wherein the core shell material comprises the core-shell material of claim 1.

25. The cell of claim 24 wherein the protonated core shell material is present in the proton conducting electrolyte in an amount of about 1% to about 99%, the proton conductive ionomer is present in the proton conducting electrolyte in an amount of about 0.1% to about 20% and the oxide dielectric is present in the proton conducting electrolyte in an amount of about 0.1% to about 40%, where all amounts are based on total volume of the electrolyte.

26. The cell of claim 24 wherein the anode comprises a conductive metal and a proton conductive metal hydride.

27. The cell of claim 24 wherein the cathode comprises a metal containing compound selected from the group consisting of metal oxides of the formula MₓO_{y} where 0.001<x≦3.00 and 0.001<y≦7.00, metal hydroxides of the formula Mₓ(OH)_{y} where 0.001<x≦1.00 and 0.001<y≦3.00 or mixtures thereof wherein in each of MₓO_{y} and Mₓ(OH)_{y}, M is selected from the group consisting of Al, Ru, Mn, Ni, Ag, alloys thereof and mixtures thereof.

28. The cell of claim 24 Wherein the metal hydride is aluminum hydride and the conductive metal is aluminum.
